(19) United States
(12) Patent Application Publication
(10) Pub. No.: US 2010/0011847 A1
(43) Pub. Date: Jan. 21, 2010

(54) Dual Application Compression Tester Adapter Assembly and Method

(75) Inventors: George R. Slivon, Kenosha, WI (US); Ryan J. Traxinger, Racine, WI (US)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: A&E Incorporated, Racine, WI (US)

(21) Appl. No.: 12/173,165

(22) Filed: Jul. 15, 2008

(51) Int. Cl. G01M 15/02

(52) U.S. Cl. 73/114.18

(57) ABSTRACT

A compression tester adapter assembly is provided for use with both 12 millimeter and 16 millimeter spark plug sockets in an internal combustion engine cylinder head. An adapter has a leading cylindrical portion including one set of external threads configured with a nominal diameter of 12 millimeters, and a trailing cylindrical portion spaced from the leading cylindrical portion and including another set of external threads configured with a nominal diameter of 16 millimeters. The axial spacing between a first leading full thread on the 12 millimeter threads and a first leading full thread on the 16 millimeter threads lies in the critical range of 0.636″-0.737″. A hose has opposite ends attached to the adapter and a connector.

### FIELD OF THE INVENTION

The present invention relates generally to engine diagnostics. More particularly, the present invention relates to internal combustion engine cylinder compression testers.

### BACKGROUND OF THE INVENTION

Compression testers are used to measure the compression pressure in an individual cylinder of an internal combustion engine. A typical compression tester consists of a compression pressure gauge with a pressure measurement range of, for example, 0-300 lbs. per square inch, and a compression pressure hose assembly that attaches to the compression pressure gauge. Typically, the compression tester hose assembly connects to a spark plug socket and engine cylinder head. Thus, the spark plug is removed from the cylinder head, and the compression tester hose assembly is threaded into the spark plug socket in order to establish fluid communication between the compression pressure gauge and the engine cylinder. The engine is then cranked for several revolutions, typically using the engine starter, in order to measure the maximum compression pressure in the engine cylinder.

The compression pressure is used to test internal combustion engines for proper compression in each cylinder. Improper compression can cause rough idling or running, back firing and poor fuel economy. Low compression in a cylinder can be an indication of worn or damaged piston rings, valves, head gasket or timing chain. A high compression reading may indicate carbon buildup in the cylinder. If the compression pressure gauge remains at the same value for several strokes, and then begins to climb, the cylinder may have a sticking valve.

Standard spark plug sockets typically include 14 millimeter (mm) nominal threads, 18 mm nominal threads, 12 mm nominal threads or 10 mm nominal threads. However, some newer engines utilize other spark plug thread sizes. For example, the Ford Triton® three-valve V8 engine family used in certain Ford trucks utilizes 16 mm nominal threads. In addition the spark plug sockets on the Ford Triton® three-valve V8 engines are located in spark plug wells that are relatively deep and, the spark plug sockets include a sealing surface at the inner end of the socket. U.S. Pat. No. 7,216,531 issued May 15, 2007 to Young et al provides a method and apparatus that permits compression testing of an engine exclusively with 16 mm nominal threaded spark plug sockets located in relatively deep spark plug wells that have a sealing surface at the inner end of the socket.

After several years of using 16 mm spark plugs in the Ford Triton® three-valve V8 engine line, a service problem arose. It was discovered that when the 16 mm spark plugs were removed, they would break off leaving a piece stuck in the cylinder head. This created a major problem since the cylinder head has to be removed from the engine to retrieve the broken spark plug part. To further compound this problem, the engine has to be removed or the truck body separated from the vehicle frame to remove the cylinder head since one-third of the cylinder head is tucked beneath the vehicle firewall. This is an expensive problem to rectify typically costing $1,500 minimum in service costs. In order to resolve the problem of 16 mm spark plug breakage, Ford redesigned their engines to use a 12 mm spark plug of conventional design which will not break off when removed.

Accordingly, it is desirable to provide an adapter assembly having a dual purpose adapter that permits compression testing of internal combustion engines that are designed with either 16 mm or 12 mm nominal spark plug sockets located in relatively deep spark plug wells that have sealing surfaces therein. It is also desirable to provide a method of measuring compression pressure in an individual cylinder of an internal combustion engine employing either a 12 mm or 16 mm thread spark plug socket.

Providing an adapter assembly that facilitates compression testing of an internal combustion engine that has 16 mm or 12 mm spark plugs poses a particular challenge because of the nature of the spark plug sockets located in relatively deep spark plug wells having sealing surfaces at the inner ends of the sockets. An adapter provided for use with both the 16 mm and 12 mm spark plug sockets needs to be uniquely designed so that it will threadably and sealingly engage the particular spark plug socket in a proper manner to enable accurate compression testing without causing mechanical interference in the socket.

### SUMMARY OF THE INVENTION

The present invention relates to a compression tester adapter assembly used with both 12 millimeter and 16 millimeter spark plug sockets in an internal combustion engine cylinder head. The assembly includes an adapter having a leading cylindrical portion including one set of external threads configured with a nominal diameter of 12 millimeters, and a trailing cylindrical portion spaced from the leading cylindrical portion and including another set of external threads configured with a nominal diameter of 16 millimeters. The axial spacing between a first leading full thread on the 12 millimeter threads and a first leading full thread on the 16 millimeter threads lies in the range of 0.636-0.737 inches. The assembly also includes a connector and a hose having opposite ends attached to the adapter and the connector.

The adapter includes a cylindrical head spaced from a trailing thread on the 16 millimeter threads, and a hose connector end extending from the cylindrical head. The adapter further includes one gasket seat located between the leading and trailing cylindrical portions. The adapter also includes one other gasket seat located between the cylindrical head and the trailing cylindrical portion. One gasket is fitted in the one gasket seat and configured to form a seal against a sealing surface spaced from an upper end of the 12 millimeter spark plug socket. One other gasket is fitted in the other gasket seat and configured to form a seal against a sealing surface adjacent the upper end of the 16 millimeter spark plug socket. The 12 millimeter threads are formed substantially along an entire axial length of the leading cylindrical portion. The 16 millimeter threads are formed partially along an axial length of the trailing cylinder portion. An outer diameter of the leading cylinder portion is less than the outer diameter of the trailing cylinder portion.

An outer diameter of the cylindrical head is larger than an outer diameter of the trailing cylindrical portion. The adapter further includes an elongated airway extending longitudinally therethrough. The airway is formed with an enlarged chamber for receiving a valve core adapted to permit air flow through the airway in one direction only. The assembly further includes a first ferrule configured to engage an outer surface of the hose at one end thereof. A second ferrule is configured to engage an outer surface of the hose at another end thereof. The first ferrule is crimped onto the hose connector end at one end thereof to affix the hose to the adapter, and the second ferrule is crimped onto a hose connector end of the connector to affix the hose to the connector. The hose has a hollow central passage providing uninterrupted sealed fluid communication between the adapter and the connector. The connector is connected to a compression tester hose assembly having a compression pressure gauge. The 12 millimeter threads are configured to be threaded into a 12 millimeter spark plug socket causing the one gasket to form the seal spaced from the upper end thereof without interference with the 16 millimeter threads. The 16 millimeter threads are configured to be threaded into the 16 millimeter spark plug socket causing the other gasket to form the seal adjacent the upper end thereof without interference from the 12 millimeter threads.

The invention further contemplates a method of measuring compression pressure in an individual cylinder of an internal combustion engine employing either a 12 millimeter or 16 millimeter threaded spark plug socket. The method includes the steps of providing an adapter having a leading cylindrical portion including one set of external threads configured with a nominal diameter of 12 millimeters, and a trailing cylindrical portion spaced from the leading cylindrical portion and including another set of external threads configured with a nominal diameter of 16 millimeters, wherein axial spacing between a first leading full thread on the 12 millimeter threads and a first leading full thread on the 16 millimeter threads lies in the range of 0.636-0.737 inches, a connector, and a hose having opposite ends attached to the adapter and connector, the adapter including a cylindrical head spaced from a trailing thread on the 16 millimeter threads, one gasket located between the leading and trailing cylindrical portions and one other gasket located between the cylindrical head and the trailing cylindrical portion; engaging the 12 millimeter or 16 millimeter threaded spark plug socket with matching external threads formed on the adapter so as to form a seal between one of the gaskets and a sealing surface near the upper end of the spark plug socket; attaching a compression tester spark plug hose and a compression pressure gauge to the connector; and transmitting a compressed gas to the compression tester spark plug hose and a compression pressure gauge.

### BRIEF DESCRIPTION OF THE DRAWINGS

FIG. 1 is a perspective view of a dual application compression tester adapter assembly embodying the present invention in use with a compression tester hose assembly, a compression tester gauge and an internal combustion engine cylinder head;

FIG. 2 is a broken away perspective view of the compression tester adapter assembly shown in FIG. 1;

FIG. 3 is an exploded view of FIG. 2;

FIG. 4 is an exploded view of an adapter used in the adapter assembly of FIG. 2;

FIG. 5 is an elevational view of one embodiment of the assembled adapter;

FIG. 6 is a sectional view taken on line 6-6 of FIG. 5;

FIG. 7 is an elevational view identical to FIG. 5, showing a maximum length assembled adapter;

FIG. 8 is an elevational view similar to FIG. 5 of a minimum length assembled adapter;

FIG. 9 is a fragmentary, cut away view of the assembled adapter of FIG. 7 threaded into a 12 millimeter nominal spark plug socket of an internal combustion engine, the remainder of the adapter assembly being omitted for clarity;

FIG. 10 is a view similar to FIG. 9 showing the adapter of FIG. 7 threaded into a 16 millimeter nominal spark plug socket;

FIG. 11 is a fragmentary, cut away view of the 12 millimeter assembled adapter of FIG. 8 threaded into a 12 millimeter nominal spark plug socket; and

FIG. 12 is a view similar to FIG. 11 showing the assembled adapter threaded into a 16 millimeter nominal spark plug socket.

### DETAILED DESCRIPTION OF THE INVENTION

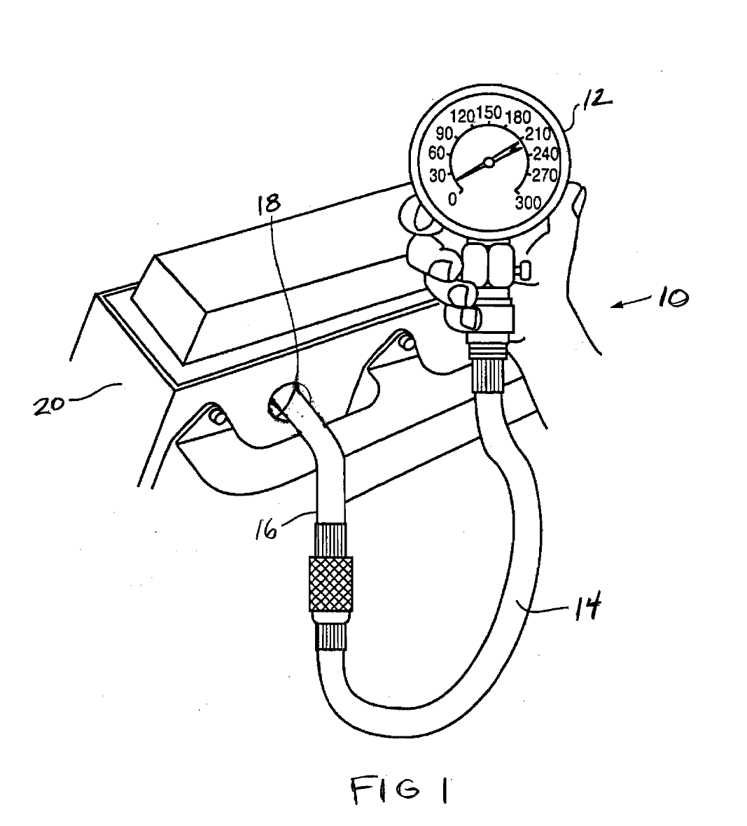

Referring now to FIG. 1, a compression tester 10 is comprised of a compression pressure gauge 12, a compression pressure tester hose 14, and a compression tester adapter assembly 16 embodying the present invention. The adapter assembly 16 enables the compression tester hose 14 to be operatively connected to a spark plug socket with either 16 millimeter or 12 millimeter nominal threads located relatively deep within a spark plug well 18 of an internal combustion engine cylinder head 20.

The adapter assembly 16 and the compression tester hose 14 permit connection of the compression pressure gauge 12 to the cylinder head 20 in order to provide fluid communication between a cylinder in the engine and the compression pressure gauge 12. Thus, when the engine is cranked through, typically, three or more revolutions, the compression pressure gauge 12 senses the maximum compression pressure developed in the engine cylinder.

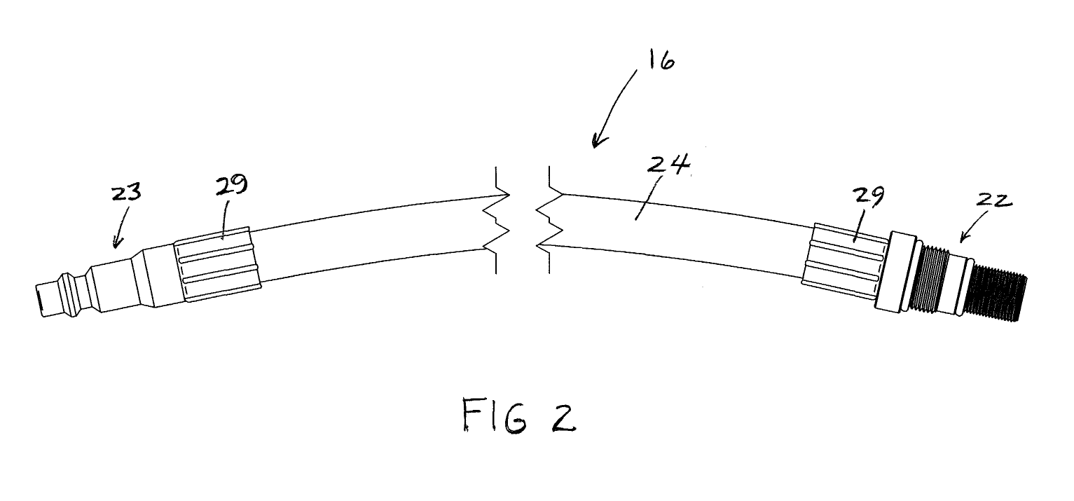

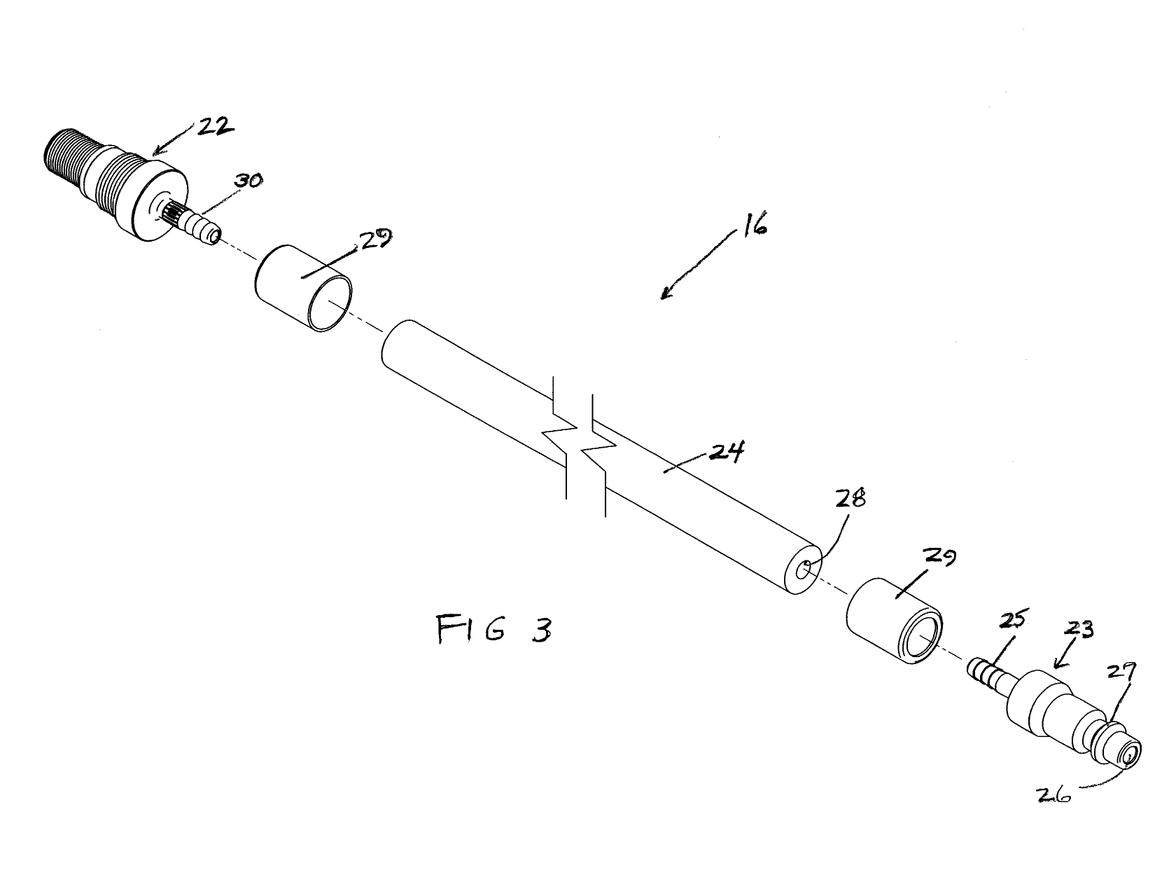

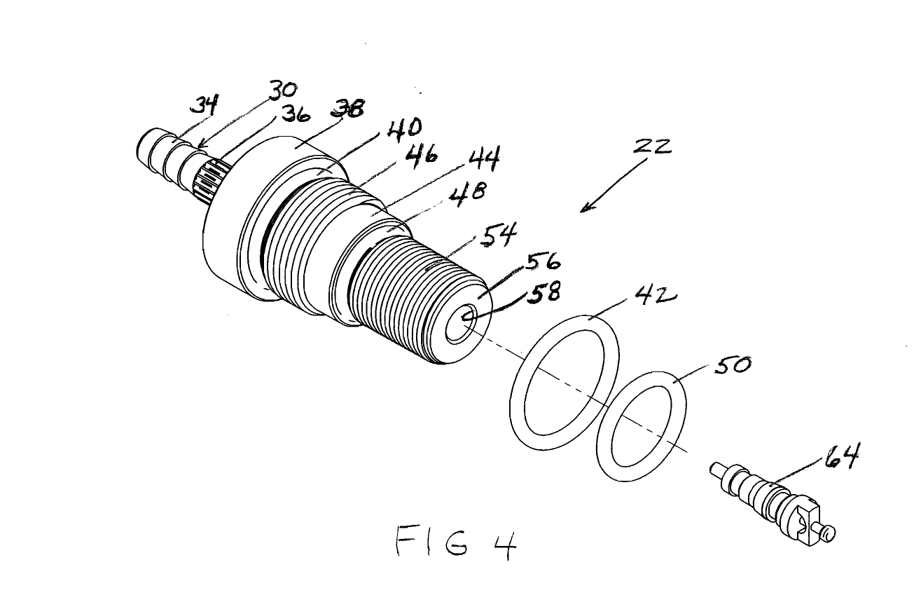

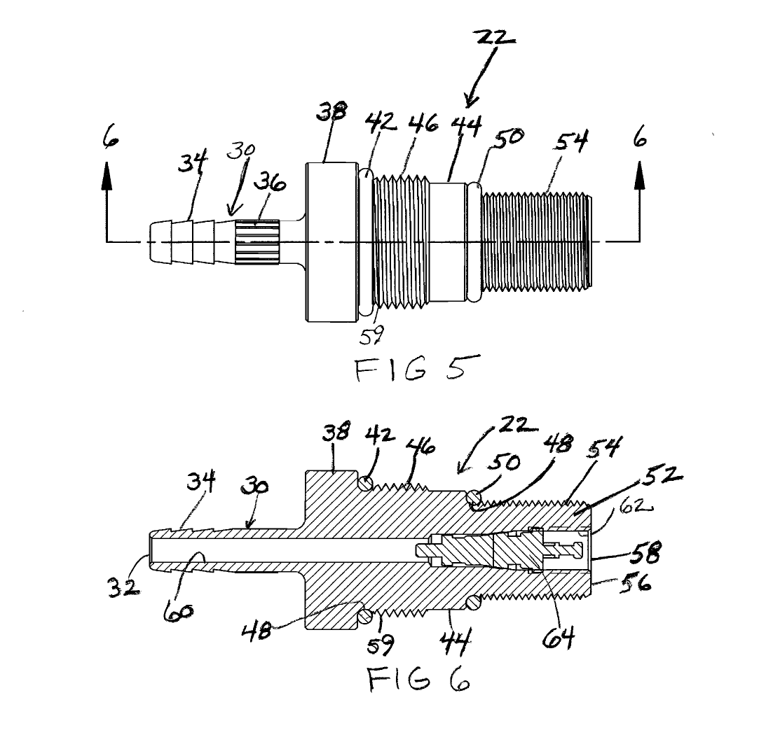

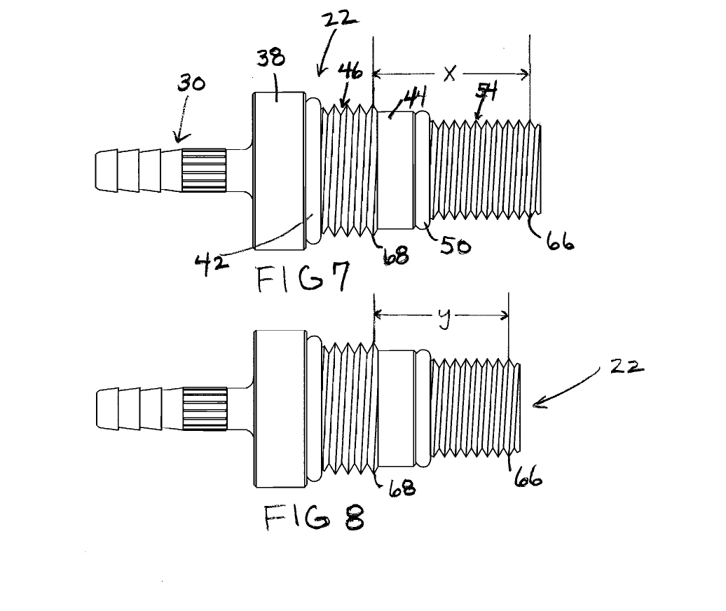

An embodiment of the adapter assembly 16 is shown in FIGS. 2 and 3. The adapter assembly 16 includes a generally cylindrical adapter 22 and a quick disconnect coupling 23 which are connected to opposite ends of a flexible hose 24. The quick disconnect coupling 23 is a conventionally available connector with a hose connector end 25, an air passage 26 formed therethrough and an attachment interface 27 which permits attachment of the adapter 22 to a standard compression tester hose 14. The coupling 23 is typically formed with a diamond knurl on a portion of its exterior surface to aid in manual rotation of the adapter 22 in order to thread the adapter 22 into a spark plug socket. The flexible hose 24 has a hollow central passage 28 of cylindrical shape extending along the longitudinal axis of the hose 24 to transmit air from the adapter 22 to the coupling 23 and thus to the compression pressure gauge 12 via the tester hose 14.

In a preferred embodiment, the flexible hose 24 is about 3/16″ in diameter and about 10″ long. This length permits access to a spark plug socket located at the bottom of a relatively deep spark plug well, for example, greater than 2″ deep. This configuration has the advantage that the tester 10 can be used to reach a spark plug socket in a Ford Triton® three valve engine including the 4.6 and 5.4 liter V8 versions as well as a 6.8 liter V10 version. The adapter 22 and the quick disconnect coupling 23 are fixedly joined to opposite ends of the flexible hose 24 using aluminum ferrules 29 which are crimped upon the hose 24 as shown in FIG. 2.

As shown in FIGS. 4-6, the adapter 22 includes an elongated hose connector segment 30 formed with an orifice 32, a series of barbs 34, and a horizontally knurled portion 36, a generally cylindrical head 38, a first gasket seat 40, a first gasket 42 conforming to the first gasket seat 40, a first or trailing cylindrical portion 44 formed with a first set of external threads 46 configured to engage 16 millimeter nominal internal threads, a second gasket seat 48, a second gasket 50 conforming to the second gasket seat 48, a second or leading cylindrical portion 52 formed with a second set of external threads 54 configured to engage 12 millimeter nominal threads, and a leading end 56 formed with an opening 58. The outside diameter of head 38 is larger than the diameter of the first cylindrical portion 44 which is larger than the diameter of the second cylindrical portion 52. Cylindrical head 38 is spaced from a trailing thread 59 on the 16 millimeter thread set 46.

As seen best in FIG. 6, the adapter 22 is formed with an elongated airway 60 extending between orifice 32 and opening 58. Airway 60 opens into an enlarged chamber 62 which retains a valve core 64 therein. As is well known, the valve core 64 acts as a one way valve to permit the flow of air in one direction only, that is from opening 58 through airway 60 and out orifice 32. Opening 58 permits entry of compressed air from an engine cylinder into the adapter 22.

In accordance with the invention, the adapter 22 is designed with critical dimensions so that it may be threadably and sealingly engaged in a proper manner in either an internally threaded 16 millimeter or 12 millimeter spark plug socket recessed relatively deep within the spark plug chamber of an internal combustion engine cylinder head 20.

FIG. 7 illustrates an adapter 22 shown in FIGS. 5 and 6 with maximum length. Preferably, the total axial length of the adapter 22 in FIG. 7 is 2.072″, and the spacing between the first full leading thread 66 of the 12 millimeter thread set 54 and the first full leading thread 68 of the 16 millimeter thread set 44 is 0.737″ as represented by the axial length x.

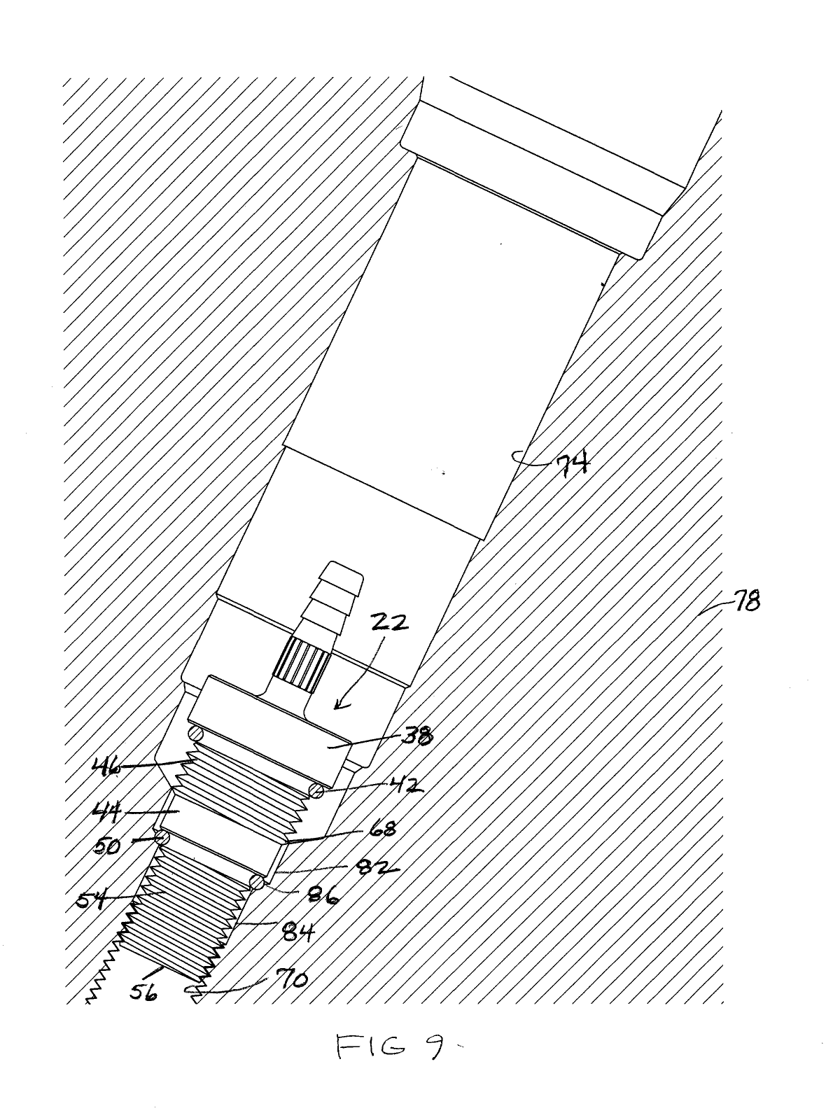

FIG. 8 illustrates an adapter 22a similar to FIG. 7, but having a shorter overall axial length of preferably 1.972″. In FIG. 8, the spacing between the first full leading thread 66 of the 12 millimeter thread set 54 and the first full leading thread 68 of the 16 millimeter thread set 44 is 0.636″ as represented by the axial length y.

The adapters 22, 22a are formed such that the axial spacing between the first full thread 66 of the 12 millimeter threads set 54 and the first full thread 68 of the 16 millimeter thread set 46 falls within the critical range of 0.636″-0.737″.

In the preferred embodiments, the external threads 46 of the adapters 22, 22a are configured in accordance with the international standards (ISO) specification 261 metric 16 millimeter nominal thread standard M16×1.5. The external threads 54 of the adapter 22 and 22a are configured in accordance with the international standard (ISO) specification 261 metric 12 millimeter nominal thread standard M12×1.25. External thread set 46 is formed partially along the axial length of the first cylindrical portion 44, and the external thread set 54 extends substantially the entire axial length of second cylindrical portion 52.

The ends 56 of the adapters 22, 22a are machined with a slight chamfered edge to prevent damage to the adapters 22, 22a or the spark plug socket threads when the adapters 22, 22a are inserted into the spark plug socket.

The adapters 22, 22a facilitate the use of an existing compression tester with either a 16 millimeter or 12 millimeter spark plug socket for an engine such as including the Ford Triton® V8 and V10 engine family.

The adapters 22 or 22a and quick disconnect coupling 23 are attached to the flexible hose 24 by inserting the respective hose connector ends 30 and 25 into opposite ends of the flexible hose 24 and crimping the ferrules 29 over the exterior of the hose 24 to compress the hose 24 over the hose connector ends 30 and 25. Thus, the adapter 22 or 22a and the coupling 23 are fixedly attached to the flexible hose 24 so that the adapter 22 or 22a can be threaded into a spark plug socket by manually rotating the assembly 16 by way of the knurl normally formed on the exterior of the coupling 23. The assembly 10 provides a continuous uninterrupted sealed or air tight fluid communication path between the orifice 32 in adapter 22 or 22a and the airway 26 terminating on the upper end of coupling 23.

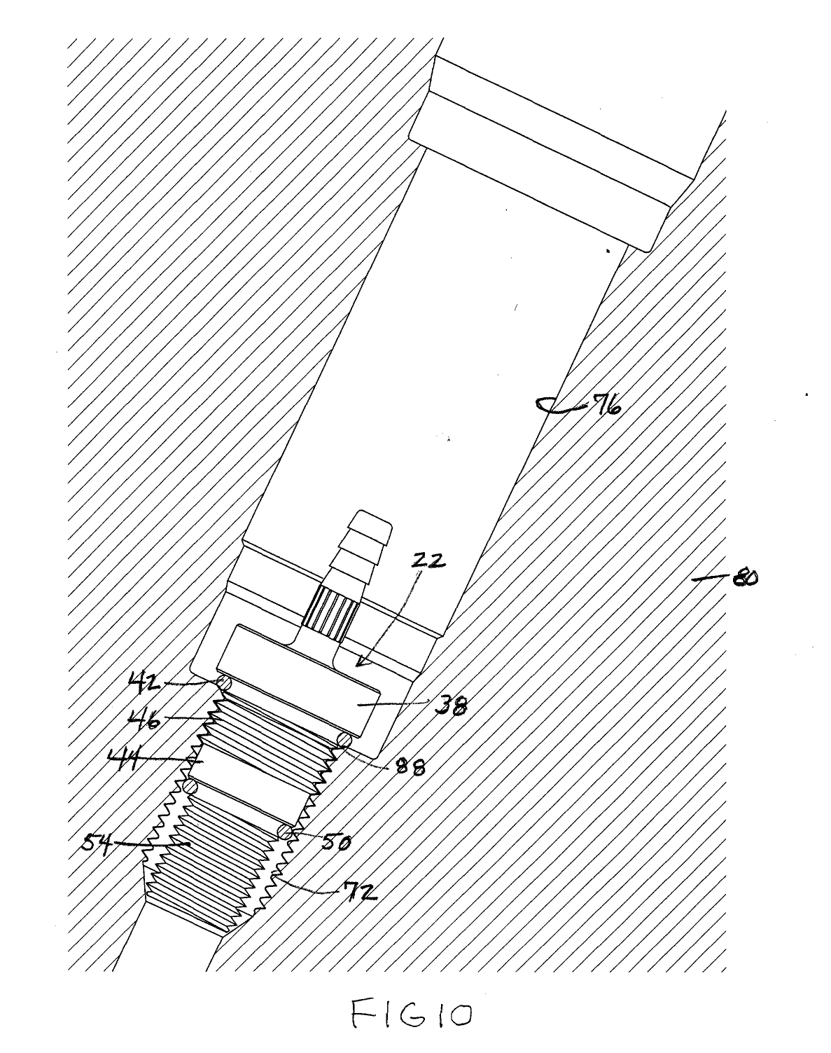

FIGS. 9-12 illustrate the application of the adapters 22 and 22a in 12 millimeter and 16 millimeter spark plug sockets 70, 72 recessed relatively deep in the spark plug wells 74, 76 of respective 12 millimeter and 16 millimeter cylinder heads 78, 80 of the Ford Triton® engine family. It should be understood that the remainder of the assembly 10, namely the ferrules 29, the hose 24 and the coupling 23, are omitted for clarity.

FIG. 9 shows the adapter 22 of FIG. 7 threadably and sealingly engaged in the 12 millimeter spark plug socket 70 of the 12 millimeter cylinder head 78. More particularly, the end 56 of the adapter 22 passes through the spark plug well 74, a first cylindrical chamber 82 and a second cylindrical chamber 84 before several leading threads of thread set 54 are threaded into spark plug socket 70 causing gasket 50 to seal tightly against sealing surface 86. The remainder of the adapter 22, namely first cylindrical portion 44, thread set 46, gasket 42 and head 38 are received with clearance within the spark plug well 70 and the first cylindrical chamber 82.

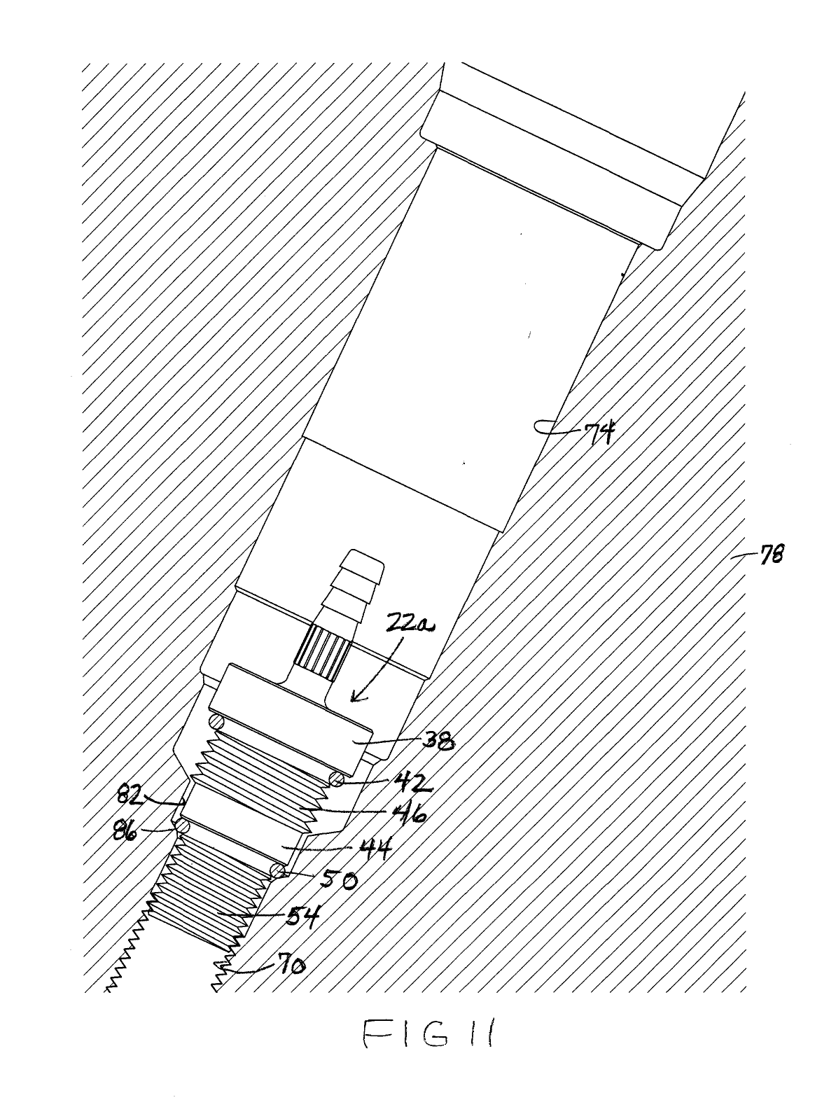

FIG. 10 shows the adapter 22 of FIG. 7 threadably and sealingly engaged in the spark plug socket 72 of the 16 millimeter cylinder head 80. Here, the 12 millimeter thread set 54, the gasket 50 and the first cylindrical portion 44 pass into the spark plug socket 72 with clearance as several threads of 16 millimeter thread set 46 are threaded into the upper end of spark plug socket 72 and the gasket 42 is sealed against the sealing surface 88.

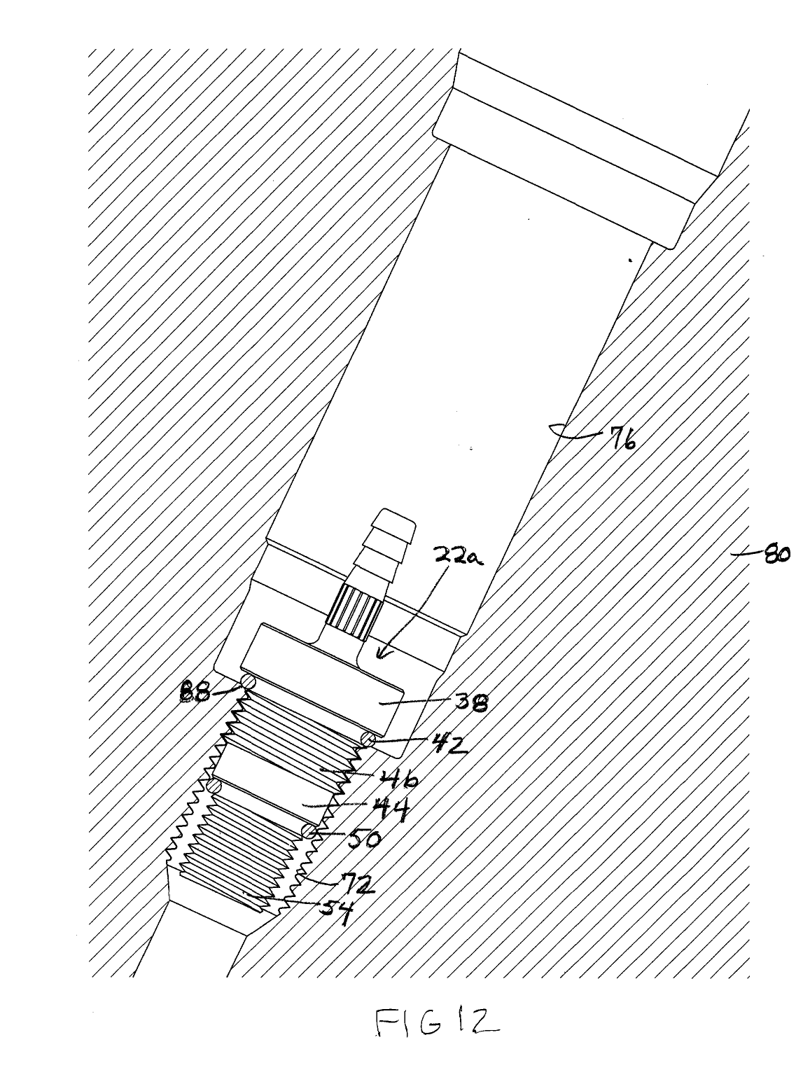

FIG. 11 shows the adapter 22a of FIG. 8 threadably and sealingly engaged in the spark plug socket 70 of the 12 millimeter cylindrical head 78. At least one full thread of the 12 millimeter thread set 54 is threaded into spark plug socket 70 causing gasket 50 to seal against sealing surface 86. Again, the remainder of the adapter 22a namely, first cylindrical portion 44, 16 millimeter thread set 46, gasket 42 and head 38, are received with clearance in the spark plug well 74 and the first cylindrical chamber 82.

FIG. 12 shows the adapter 22a of FIG. 8 threadably and sealingly engaged in the spark plug socket 72 of the 16 millimeter cylinder head 80. Here, the 12 millimeter thread set 54, the gasket 50 and the first cylindrical portion 44 pass into the spark plug socket 72 with clearance as the 16 millimeter thread set 46 is threaded into the upper end of the spark plug socket 72 and gasket 42 is sealed against sealing surface 88.

The present invention thus provides an adapter assembly 16 having an adapter 22, 22a that can be threadably and sealingly engaged either in a 12 millimeter or 16 millimeter spark plug socket 70 or 72 recessed relatively deep in an internal combustion engine cylinder head 20 without causing mechanical interference therein. The adapter 22, 22a may have a variable overall length and a variable number of threads in the 16 millimeter or 12 millimeter thread sets 46 or 54 as long as the spacing between the first full thread of the 12 millimeter thread set 54 and the first full thread of the 16 millimeter thread set 46 lies in the critical range of 0.636″-0.737″.

While the invention has been described with reference to a preferred embodiment, those skilled in the art will appreciate that certain substitutions, alterations and omissions may be made without departing from the spirit thereof. Accordingly, the foregoing description is meant to be exemplary only and should not be deemed limitative on the scope of the invention set forth with the following claims.

We claim:

1. A compression tester adapter assembly used with both 12 millimeter and 16 millimeter spark plug sockets in an internal combustion engine cylinder head, the assembly comprising:
an adapter having a leading cylindrical portion including one set of external threads configured with a nominal diameter of 12 millimeters, and a trailing cylindrical portion spaced from the leading cylindrical portion and including another set of external threads configured with a nominal diameter of 16 millimeters, wherein axial spacing between a first leading full thread on the 12 millimeter threads and a first leading full thread on the 16 millimeter threads lies in the range of 0.636″-0.737″;
a connector; and
a hose having opposite ends attached to the adapter and the connector.

2. The assembly of claim 1, wherein the adapter includes a cylindrical head spaced from a trailing thread on the 16 millimeter threads, and a hose connector end extending from the cylindrical head.

3. The assembly of claim 1, wherein the adapter further includes one gasket seat located between the leading and trailing cylindrical portions.

4. The assembly of claim 2, wherein the adapter further includes one other gasket seat located between the cylindrical head and the trailing cylindrical portion.

5. The assembly of claim 3, wherein the adapter further includes one gasket fitted in the one gasket seat and configured to form a seal against a sealing surface spaced from an upper end of the 12 millimeter spark plug socket.

6. The assembly of claim 4, wherein the adapter further includes one other gasket fitted in the other gasket seat and configured to form a seal adjacent a sealing surface adjacent an upper end of the 16 millimeter spark plug socket.

7. The assembly of claim 1, wherein the 12 millimeter threads are formed substantially along an entire axial length of the leading cylindrical portion.

8. The assembly of claim 1, wherein the 16 millimeter threads are formed partially along an axial length of the trailing cylindrical portion.

9. The assembly of claim 1, wherein an outer diameter of the leading cylindrical portion is less than an outer diameter of the trailing cylindrical portion.

10. The assembly of claim 2, wherein an outer diameter of the cylindrical head is larger than an outer diameter of the trailing cylindrical portion.

11. The assembly of claim 1, wherein the adapter further includes an elongated airway extending longitudinally therethrough.

12. The assembly of claim 11, wherein the airway is formed with an enlarged chamber for receiving a valve core adapted to permit air flow through the airway in one direction only.

13. The assembly of claim 2, further comprising:
a first ferrule configured to engage an outer surface of the hose at one end thereof, and
a second ferrule configured to engage an outer surface of the hose at another end thereof,
wherein the first ferrule is crimped onto the hose connector at one end thereof to affix the hose to the adapter, and the second ferrule is crimped onto a hose connector end of the connector to affix the hose to the connector.

14. The assembly of claim 13, wherein the hose has a hollow central passage providing uninterrupted sealed fluid communication between the adapter and the connector.

15. The assembly of claim 1, wherein the connector is connected to a compression tester hose assembly having a compression pressure gauge.

16. The assembly of claim 5, wherein the 12 millimeter threads are configured to be threaded into the 12 millimeter spark plug socket causing the one gasket to form the seal spaced from the upper end thereof without interference from the 16 millimeter threads.

17. The assembly of claim 6, wherein the 16 millimeter threads are configured to be threaded into the 16 millimeter spark plug socket causing the other gasket to form the seal adjacent the upper end thereof without interference from the 12 millimeter threads.

18. A method of measuring compression pressure in an individual cylinder of an internal combustion engine employing either a 12 millimeter or 16 millimeter thread spark plug socket, the method comprising the steps of:
providing an adapter having a leading cylindrical portion including one set of external threads configured with a nominal diameter of 12 millimeters, and a trailing cylindrical portion spaced from the leading cylindrical portion and including another set of external threads configured with a nominal diameter of 16 millimeters, wherein axial spacing between a first leading full thread on the 12 millimeter threads and a first leading full thread on the 16 millimeter threads lies in the range of 0.636″-0.737″, a connector and a hose having opposite ends attached to the adapter and the connector, the adapter including a cylindrical head spaced from a trailing thread on the 16 millimeter threads, one gasket located between the leading and trailing cylindrical portions and one other gasket located between the cylindrical head and the trailing cylindrical portion;
engaging the 12 millimeter or 16 millimeter threaded spark plug socket with matching external threads formed on the adapter so as to form a seal between one of the gaskets and a sealing surface near the upper end of the spark plug socket;
attaching a compression tester spark plug hose and a compression pressure gauge to the connector; and
transmitting a compressed gas to the compression pressure spark plug hose and compression pressure gauge.
